(19) United States
(12) Patent Application Publication
(10) Pub. No.: US 2025/0117462 A1
(43) Pub. Date: Apr. 10, 2025

(54) Methods and Systems of Controlling Access to Device Functionality

(71) Applicant: Richard Marra, JR., Lake Forest, IL (US)

(72) Inventor: Richard Marra, JR., Lake Forest, IL (US)

(21) Appl. No.: 18/483,524

(22) Filed: Oct. 10, 2023

(51) Int. Cl. G06F 21/30; G09B 5/02

(52) U.S. Cl. CPC G06F 21/30; G09B 5/02

(57) ABSTRACT

Computer-implemented access control methods, systems, and computer-readable media are described. In some implementations a computer-implemented method may include determining, using a computer processor, whether authentication is required for access to a portion of functionality of a device. In some implementations, based on a determination that authentication is required, the method may include identifying a question to be answered to gain access to the portion of functionality of the device. A frequency of the authentication may be determined by an administrator. A user of the device may be prompted to provide a response to the question, and in response to receiving a correct response to the question, access may be granted to the portion of functionality of the device. In some implementations machine learning may be used to identify an appropriate question to authenticate the user.

### FIELD

Some implementations are generally related to controlling access to functionality of devices of minors or other supervised device users.

### BACKGROUND

An increasing number of minors have devices. These devices may provide a wide range of applications which can productive, educational, social, recreational, and in some cases essential for communication, safety, and/or transportation. However, parents, guardians, teachers and mentors are faced with increasing challenges to education by the distractions provided by some devices and applications. Because these devices can be necessary for safety and in some cases homework or education as well as for social connections, outright banning of the devices and applications is difficult. Parents, guardians, teachers and mentors are faced with an ongoing monitoring situation that can be stressful, time consuming, and difficult to perform.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method and/or a device to grant access to device functionality in response to a user correctly answering questions. In some implementations the questions may be educational questions designed to improve knowledge of a user while allowing a user to earn access to the desired device functionality.

Computer-implemented access control methods, systems, and computer-readable media are described. In some implementations a computer-implemented method may include determining, using a computer processor, whether authentication is required for access to a portion of functionality of a device. In some implementations, based on a determination that authentication is required, the method may include identifying a question to be answered to gain access to the portion of functionality of the device. A frequency of the authentication may be determined by an administrator. A user of the device may be prompted to provide a response to the question, and in response to receiving a correct response to the question, access may be granted to the portion of functionality of the device. In some implementations machine learning may be used to identify an appropriate question to authenticate the user. In some implementations a correct answer to an authentication question may comprise an answer previously provided by someone other than the user of the device.

In some implementations, in response to receiving an incorrect answer to the question, a user may be provided with access to training material related to subject matter of the question. The user may be provided with another opportunity to answer the question or a second question on the same subject matter. In some implementations, the question may comprise a question directed towards educational subject matter. In some implementations, the question may comprise a question of common knowledge designed to entertain the user.

In some implementations, the identifying of the question to be answered to gain the access to the portion of functionality of the device may include providing one or more inputs to a machine learning model, and receiving from the machine learning model a question directed to an educational level based on the one or more inputs.

In some implementations, the determining of whether authentication is required for access to the portion of functionality of the device may include at least one of: detecting an execution of a specified program on the device, determining that a specified period of time has elapsed since a prior authentication, determining that a prior authentication has failed, or determining that it is currently a specified time period requiring authentication.

In some implementations, access control methods may further include installing on the device a client for controlling access to the portion of functionality of the device. In some implementations the method may further include installing an administrative application for the client on a second device, separate from the device.

In some implementations a system for controlling access may include one or more processors coupled to a computer-readable medium having stored thereon software instructions that, when executed by the one or more processors, cause the one or more processors to perform operations including determining whether authentication is required for access to a portion of functionality of a device. Based on a determination that authentication is required, the operations may include identifying a question to be answered to gain access to the portion of functionality of the device. A frequency of the authentication may be determined by an administrator. The operations may include prompting the user of the device to provide a response to the question, and in response to receiving a correct response to the question, granting access to the portion of functionality of the device.

In some implementations an answer to the question may include an answer previously provided by someone other than the user of the device.

In some implementations, operations performed by the device may further include, in response to receiving an incorrect answer to the question, providing the user with access to training material related to subject matter of the question, and providing another opportunity to answer the question or a second question on the same subject matter.

In some implementations, the question may include a question directed towards educational subject matter. In some implementations, the question may include a question of common knowledge designed to entertain the user.

In some implementations, the identifying of the question to be answered to gain the access to the portion of functionality of the device may include providing one or more inputs to a machine learning model, and receiving a question directed to the user's educational level based on the one or more inputs.

In some implementations, the determining of whether authentication is required for access to the portion of functionality of the device may include at least one of: detecting an execution of a specified program on the device, determining that a specified period of time has elapsed since a prior authentication, determining that a prior authentication has failed, or determining that it is currently a specified time period requiring authentication.

In some implementations, the operations performed by the device may further include installing on the device a client for controlling access to the portion of functionality of the device.

In some implementations, the operations performed by the device may further include installing an administrative application for the client on a second device, separate from the device.

In some implementations, a non-transitory computer-readable medium having stored thereon software instructions that, when executed by one or more processors, may cause the one or more processors to perform operations for controlling access to device functionality. The operations may include determining whether authentication is required for access to a portion of functionality of a device and, based on a determination that authentication is required, identifying a question to be answered to gain access to the portion of functionality of the device. A frequency of the authentication may be determined by an administrator. In some embodiments, the operations may include prompting the user of the device to provide a response to the question, and in response to receiving a correct response to the question, granting access to the portion of functionality of the device.

In some embodiments, the identifying of the question to be answered to gain the access to the portion of functionality of the device may include providing one or more inputs to a machine learning model, and receiving a question directed to the user's educational level based on the one or more inputs.

### BRIEF DESCRIPTION OF THE DRAWINGS

FIG. 1 is a block diagram of an example system and a network environment which may be used for one or more implementations described herein.

FIG. 2 is a block diagram of an example computing device which may be used for one or more implementations described herein.

FIG. 3 is a flowchart of an example process which may be used for one or more implementations described herein.

FIG. 4 is a flowchart of an example process which may be used for one or more implementations described herein.

### DETAILED DESCRIPTION

Some implementations include application access control methods and systems.

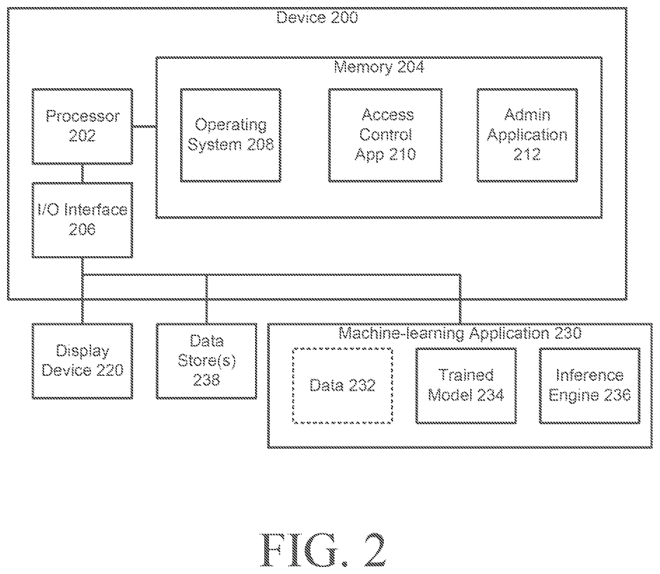

When performing application access control functions, it may be helpful for a system to identify appropriate questions to ask a user. To make identify an appropriate question, a probabilistic model (or other model as described below in conjunction with FIG. 2) can be used to make an inference about an appropriate level of difficulty of a question. Accordingly, it may be helpful to make an inference about a user's educational level based on grade level, scores, answers to prior questions, etc. Other aspects can be predicted or suggested as described below.

The systems and methods provided herein may overcome one or more deficiencies of some conventional access control systems and methods. For example, limiting access based on time or a simple password may not provide any educational benefit and may cause resentment and frustration in a user. Systems that merely ask questions may not identify appropriate questions and may further frustrate a user.

The example systems and methods described herein may overcome one or more of the deficiencies of conventional access control systems to provide users with access while providing an educational benefit and building user self-esteem. The example systems and methods may provide support or training for a user that gets a question wrong. This may the allow the user to learn something that will be beneficial to their education while gaining access to an application on their device. A technical problem of some conventional access control systems may be that such systems do not suggest appropriate questions and/or provide support. In conventional access control systems, a user may be frustrated by questions that are too difficult which preclude access to applications. Alternatively, conventional systems may ask questions that are known by the user for security purposes but which provide no educational benefit. Furthermore, conventional systems may allow a user to “game” the system but answering enough questions to allow extended access to social applications and other applications. The example systems and methods may be set by an administrator to require periodic authentication to access specified functionality of a user device.

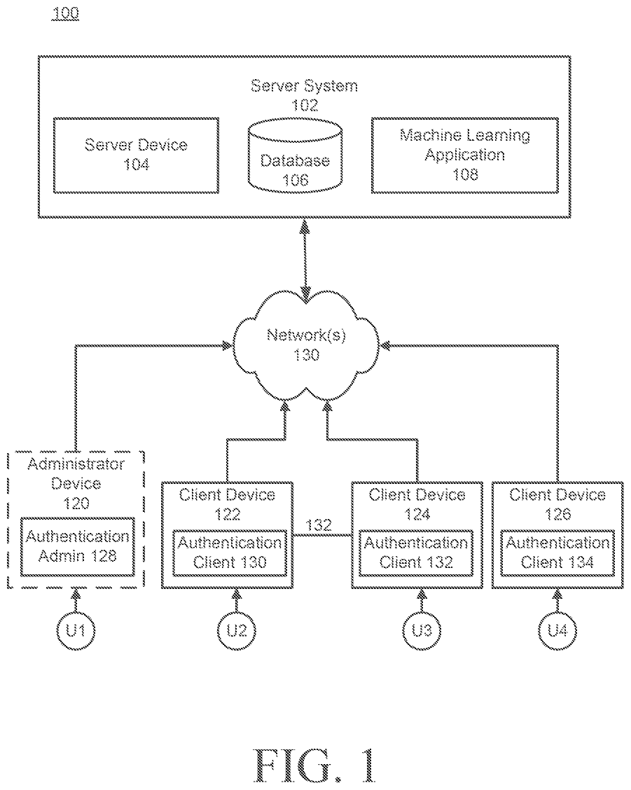

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and machine learning application 108. Network environment 100 also can include an administrator device 120 and one or more client devices, e.g., client devices 122, 124, and 126, which may communicate with each other and/or with server system 102 via network 130. In some implementations there may be multiple administrator devices or devices may have both administrator and client functionality. In some implementations administrator device 120 may have authentication admin application 128 which may control access to functionality of one or more client devices 122, 124, and 126. In some implementations, an administrator device 120 may not be used and client devices 122, 124, and/or 126 may contain an authentication admin application. Client devices 122, 124, and/or 126 may contain authentication client applications 130, 132, and 134, respectively. As described in further detail below, authentication client applications 130, 132, and 134 may grant access applications of client devices 122, 124, and 126, respectively.

Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, database 106, and administrator device 120, and shows four blocks for client devices 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of administrator and client devices. In some implementations, a device may contain both client and administrator functionality. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using administrator device 120 and/or respective client devices 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, administrator device 120 and/or respective client devices 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on administrator device 120 and/or client devices 122, 124, and 126 (or alternatively on server system 102). Such an interface can be displayed using software on the administrator device, software on the client device, software on the server device, and/or a combination of administrator software, client software, and/or server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102, administrator device 120, and/or one or more client devices 122-126 can provide a system for granting access to device functionality. For example, one or more client devices may be devices of a minor or another supervised or mentored user. These devices may provide a wide range of applications which can productive, educational, recreational, but also are potentially distracting. For example, client devices may represent devices of a minor or a student that contain social media applications (e.g., FACEBOOK®, X® (formerly TWITTER®), INSTAGRAM®, TIKTOK®, SNAPCHAT®, YOUTUBE®, etc.), games, or other applications that can detract from productive time. A parent, guardian, teacher, or other mentor or supervisor may wish to help a student or minor use some of this time more productively. Thus, in some implementations an application may be used to require authentication to gain access to more or applications or portions of applications on a client device. Whether or not authentication is required may be determined by one or more factors. For example, whether or not authentication is required may depend on whether a particular application is specified as an application identified for authentication by a parent, guardian, teacher, or other mentor or supervisor. In some implementations the need for authentication may be determined on a date, time, day of the week, location, a last authentication time, or other factors. In some implementations, whether authentication is needed may be based on a learning schedule of a user, a grade of a user, an upcoming assignment of a user, and/or a prior success level of authentication. Some areas of functionality may not require authentication (e.g., phone calls, maps, emergency functionality, school applications, etc.).

In some implementations, to authenticate a user may be prompted to answer one or more questions. Questions may be directed towards educational subject matter appropriate for the user. Questions may also be common knowledge or fun facts. Questions may be designed to educate and/or entertain. Questions may be designed to bolster self-esteem. Different question modes may be set by an administrator. For example, a standard mode may present only a single question necessary for authentication. A challenge mode may present multiple questions.

In some implementations, questions may be identified by a parent, guardian, teacher, or other mentor or supervisor. Additionally, or alternatively, questions may be identified by machine learning (e.g., artificial intelligence). For example, machine learning application 108 may be utilized to identify questions appropriate for a user based on education level, subject matter, results of prior questions, and/or other factors. Questions may be designed to progress in difficultly based on prior results, grades, or other factors. Machine learning application 108 may be used to determine an appropriate level of progression within a subject. In some implementations, identification of questions and progression of questions may be performed manually (e.g., arranging questions in tiers in advance). For example, questions may be arranged within a subject matter in different levels or tiers based on grade level, age level, test scores, subject grades, past authentication question responses, and/or other factors. In some implementations, questions may be loaded periodically into a system for an authentication application in advance of a test, project, quiz, or other assignment. For example, questions may be provided by a school in advance of a test and a student may periodically be prepared with practice questions during authentication attempts.

If a user gets an authentication question correct, access may be granted to the desired application or functionality. In some implementations, multiple questions may be required to gain access to the desired application or functionality.

In some implementations, rewards, coupons, recognition, stars, stickers, points, or other incentives may be used to build self-esteem of users and to encourage participation in authentication efforts. Incentives may be tailored based on user age or other parameters. In some implementations a user may have a choice of incentives. In some implementations, incentives may include extra credit towards a school assignment, bonus points for a test, an opportunity to redo a homework (e.g., after having answered authentication questions on that subject matter) or other school related rewards. In some implementations, administrators (e.g., parents, guardians, teachers, etc.) may view a dashboard view of the authentication administration application and view a student's/child's progress. Rewards may be given by the administrator in recognition of the progress. Comments, encouragement, and suggestions may also be provided.

If a user gets an authentication question wrong, several options may be presented to the user. For example, a user may be presented with training material related to the subject matter of the authentication question such as educational video content, audio content, visual content, and/or textual content. The material may be integrated into an authentication application or accessed via link or download, etc. A user may also be presented with other options when an authentication question is incorrect. For example, a user may be able to retry a question or to try a second question in a same subject area. Additionally, a user may be able to cancel the authentication attempt but access to the functionality may not be granted.

Installation of an authentication application may involve one or more devices. For example, an authentication application (e.g., authentication admin 128) may first be setup on an administrator device (e.g., administrator device 120). Authentication clients (e.g., authentication clients 130, 132, and 134) may be installed on one or more client devices (e.g., client devices 122, 124, and 126). An administrator may configure authentication application settings for one or more client devices (e.g., client devices 122, 124, and 126). In some implementations, an administrator device may not be used and an authentication admin application may be installed on a client device together with an authentication client application.

Installation of an authentication admin application may be by download via a link or other methods. In some implementations, to install an authentication client application a user of the authentication admin application may load a screen providing a QR code. This QR code may be scanned by the client device to load an authentication client application on a client device. In some implementations, a QR code may direct a client device to an app store.

Various implementations of features described herein can use any type of system and/or service. Any type of electronic device can make use of features described herein. Some implementations can provide one or more features described herein on client or server devices disconnected from or intermittently connected to computer networks.

FIG. 2 is a block diagram of an example device 200 which may be used to implement one or more features described herein. In one example, device 200 may be used to implement a client device, e.g., any of client devices 122-126 shown in FIG. 1. In another example, device 200 may be used to implement an administrator device, e.g., administrator device 120. Alternatively, device 200 can implement a server device, e.g., server device 104, etc. In some implementations, device 200 may be used to implement a client device, a server device, or a combination of the above. Device 200 can be any suitable computer system, server, or other electronic or hardware device as described above.

One or more methods described herein (e.g., application access control) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 200 includes a processor 202, a memory 204, and I/O interface 206. Processor 202 can be one or more processors and/or processing circuits to execute program code and control basic operations of the device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 202 may include one or more co-processors that implement neural-network processing. In some implementations, processor 202 may be a processor that processes data to produce probabilistic output, e.g., the output produced by processor 202 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

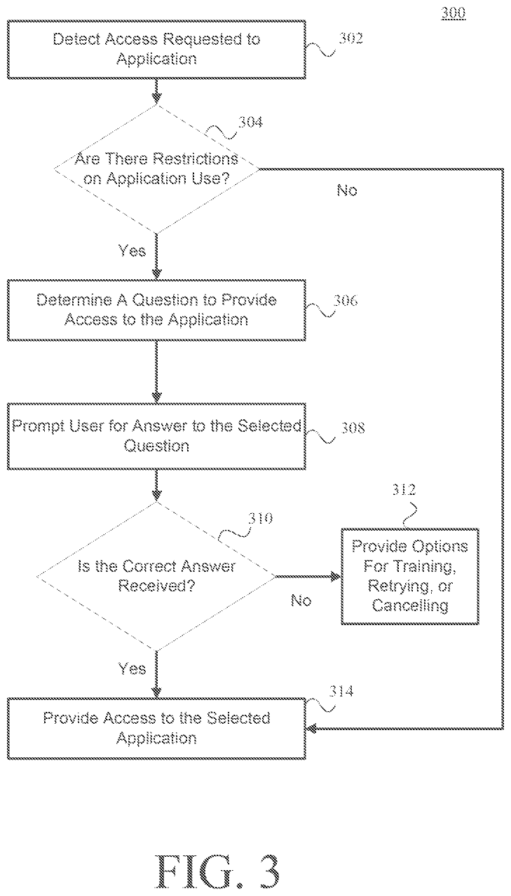

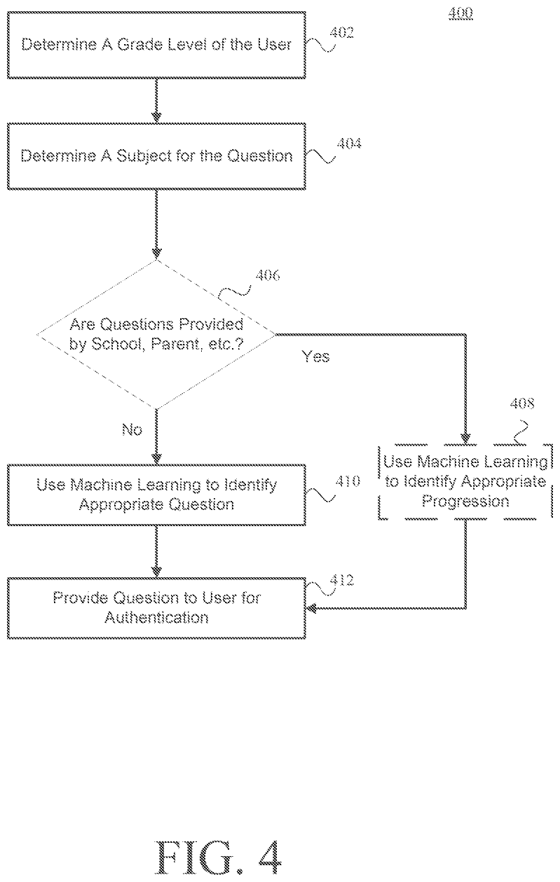

Memory 204 is typically provided in device 200 for access by the processor 202, and may be any suitable processor-readable storage medium, such as random access memory (RAM), read-only memory (ROM), Electrically Erasable Read-only Memory (EEPROM), Flash memory, etc., suitable for storing instructions for execution by the processor, and located separate from processor 202 and/or integrated therewith. Memory 204 can store software operating on the server device 200 by the processor 202, including an operating system 208, machine-learning application 230, access control application 210, and an admin application 212. Other applications may include applications such as a data display engine, web hosting engine, image display engine, notification engine, social networking engine, etc. In some implementations, the machine-learning application 230 and access control application 210 can each include instructions that enable processor 202 to perform functions described herein, e.g., some or all of the methods of FIGS. 3 and 4.

The machine-learning application 230 can include one or more implementations for which supervised and/or unsupervised learning can be used. The machine learning models can include multi-task learning based models, residual task bidirectional LSTM (long short-term memory) with conditional random fields, etc. The Device can also include an admin application 212 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 230 may utilize Bayesian classifiers, support vector machines, neural networks, or other learning techniques. In some implementations, machine-learning application 230 may include a trained model 234, an inference engine 236, and data 232. In some implementations, data 232 may include training data, e.g., data used to generate trained model 234. For example, training data may include any type of data suitable for training a model for identifying an authentication question or determining a progression of authentication questions (e.g., a level of increase or decrease in difficulty based on one or more factors). Training data may be obtained from any source, e.g., a data repository specifically marked for training, data for which permission is provided for use as training data for machine-learning, etc. In implementations where one or more users permit use of their respective user data to train a machine-learning model, e.g., trained model 234, training data may include such user data. In implementations where users permit use of their respective user data, data 232 may include permitted data.

In some implementations, the trained model 234 may be generated, e.g., on a different device, and be provided as part of machine-learning application 230. In various implementations, the trained model 234 may be provided as a data file that includes a model structure or form, and associated weights. Inference engine 236 may read the data file for trained model 234 and implement a neural network with node connectivity, layers, and weights based on the model structure or form specified in trained model 234.

Machine-learning application 230 also includes an inference engine 236. Inference engine 236 is configured to apply the trained model 234 to data, such as application data 232, to provide an inference. In some implementations, inference engine 236 may include software code to be executed by processor 202. In some implementations, inference engine 236 may specify circuit configuration (e.g., for a programmable processor, for a field programmable gate array (FPGA), etc.) enabling processor 202 to apply the trained model. In some implementations, inference engine 236 may include software instructions, hardware instructions, or a combination. In some implementations, inference engine 236 may offer an application programming interface (API) that can be used by operating system 208 and/or access control application 210 to invoke inference engine 236, e.g., to apply trained model 234 to application data 232 to generate an inference.

In some implementations, machine-learning application 230 may be implemented in an offline manner. In these implementations, trained model 234 may be generated in a first stage and provided as part of machine-learning application 230. In some implementations, machine-learning application 230 may be implemented in an online manner. For example, in such implementations, an application that invokes machine-learning application 230 (e.g., operating system 208, one or more of an access control application 210 or other applications) may utilize an inference produced by machine-learning application 230, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 234, e.g., to update embeddings for trained model 234.

Any of software in memory 204 can alternatively be stored on any other suitable storage location or computer-readable medium. In addition, memory 204 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 204 and any other type of storage (magnetic disk, optical disk, magnetic tape, or other tangible media) can be considered “storage” or “storage devices.”

I/O interface 206 can provide functions to enable interfacing the server device 200 with other systems and devices. Interfaced devices can be included as part of the device 200 or can be separate and communicate with the device 200. For example, network communication devices, storage devices (e.g., memory and/or database 106), and input/output devices can communicate via I/O interface 206. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 206 can include one or more display devices 220 and one or more data stores 238 (as discussed above). The display devices 220 that can be used to display content, e.g., a user interface of an output application as described herein. Display device 220 can be connected to device 200 via local connections (e.g., display bus) and/or via networked connections and can be any suitable display device. Display device 220 can include any suitable display device such as an LCD, LED, or plasma display screen, CRT, television, monitor, touchscreen, 3-D display screen, or other visual display device. For example, display device 220 can be a flat display screen provided on a mobile device, multiple display screens provided in a goggles or headset device, or a monitor screen for a computer device.

The I/O interface 206 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 2 shows one block for each of processor 202, memory 204, I/O interface 206, and software blocks 208, 212, and 230. These blocks may represent one or more processors or processing circuitries, operating systems, memories, I/O interfaces, applications, and/or software modules. In other implementations, device 200 may not have all of the components shown and/or may have other elements including other types of elements instead of, or in addition to, those shown herein. While some components are described as performing blocks and operations as described in some implementations herein, any suitable component or combination of components of environment 100, device 200, similar systems, or any suitable processor or processors associated with such a system, may perform the blocks and operations described.

In some implementations, the access control system could include a machine-learning model (as described herein) for tuning the system to potentially provide improved accuracy. Inputs to the machine learning model can include information about a grade level of a student, test scores of a student, assignment grades of student, performance on authentication questions, etc. Output of the machine-learning application can include identification of a question appropriate for a user's academic level, grade level, specified subject matter, etc. In some implementations, output can also include identification of a proper order to ask existing questions (e.g., a level of difficulty in order to progress, reinforce, or review based on a student's authentication attempt results).

In some implementations, machine-learning application 230 may be external to and/or remote from device 200. In some implementations, one or more portions of machine-learning application 230 may be internal to or included in device 200.

FIG. 3 is a flowchart of an example process 300 which may be used for one or more implementations described herein. According to some implementations, the process may begin at operation 302. In operation 302, the process may detect a request for access to an application on a device.

In operation 304, the process may determine whether there are restrictions on the application use for the user of the device. For example, whether or not authentication is required may depend on whether a particular application is specified as an application identified for authentication by a parent, guardian, teacher, or other mentor or supervisor. In some implementations the need for authentication may be determined on a date, time, day of the week, location, a last authentication time, or other factors. In some implementations, whether authentication is needed may be based on a learning schedule of a user, a grade of a user, an upcoming assignment of a user, and/or a prior success level of authentication. Some areas of functionality may not require authentication (e.g., phone calls, maps, emergency functionality, school applications, etc.). If there are no restrictions on use the method may proceed to operation 314. If there are restrictions on use, the method may proceed to operation 306.

In operation 306, the method 300 may determine a question to provide in order for a user to gain access to desired functionality. A user may be prompted to answer one or more questions. Questions may be directed towards educational subject matter appropriate for the user. Questions may also be common knowledge or fun facts. Questions may be designed to educate and/or entertain. Questions may be designed to bolster self-esteem. Different question modes may be set by an administrator. For example, a standard mode may present only a single question necessary for authentication. A challenge mode may present multiple questions.

In some implementations, questions may be identified by a parent, guardian, teacher, or other mentor or supervisor. Additionally, or alternatively, questions may be identified by machine learning (e.g., artificial intelligence). For example, machine learning application 108 may be utilized to identify questions appropriate for a user based on education level, subject matter, results of prior questions, and/or other factors. Questions may be designed to progress in difficulty based on prior results, grades, or other factors. Machine learning application 108 may be used to determine an appropriate level of progression within a subject. In some implementations, identification of questions and progression of questions may be performed manually (e.g., arranging questions in tiers in advance). For example, questions may be arranged within a subject matter in different levels or tiers based on grade level, age level, test scores, subject grades, past authentication question responses, and/or other factors. In some implementations, questions may be loaded periodically into a system for an authentication application in advance of a test, project, quiz, or other assignment. For example, questions may be provided by a school in advance of a test and a student may periodically be prepared with practice questions during authentication attempts (e.g., whenever they attempt applications which require authentication as determined by an administrator).

In operation 308, a user may be prompted for an answer to the selected question. In operation 310, the method 300 may determine whether a correct answer to the question was received. In some implementations questions may be presented in a manner lessening the likelihood of subjective answers (e.g., multiple choice). If it is determined that a correct answer was not received, the method 300 may proceed to operation 312. If it is determined that a correct answer has been received, the method 300 may proceed to operation 314.

At operation 312, in response to an incorrect answer being received, several options may be offered. In some implementations, a user may be presented with training material related to the subject matter of the authentication question such as educational video content, audio content, visual content, and/or textual content. The material may be integrated into an authentication application or accessed via link or download, etc. A user may also be presented with other options when an authentication question is incorrect. For example, a user may be able to retry a question or to try a second question in a same subject area. Additionally, a user may be able to cancel the authentication attempt, but access to the functionality may not be granted. Access attempts may be logged and may be used by an administrator to gauge progress in one or more subjects, to reward users, and/or to assist in user's education.

At operation 314, in response to a correct answer being received, access to the desired functionality may be granted.

FIG. 4 is a flowchart of an example process 400 which may be used for one or more implementations described herein. According to some implementations, the process may begin at operation 402.

In operation 402, the process may determine a grade level of the use. A grade level may be provided by a parent, guardian, teacher, mentor, school administration, etc. In some implementations determining a grade level of a user may include determining an age, an education level, test scores, a course grade, or other indications of a level of understanding of one or more subject areas. For example, information may be gathered by subject area as some users may have a higher or lower level of understanding in different subjects.

In operation 404, a subject for an authentication question may be determined. In some implementations, a subject may be determined at random based on a grade appropriate curriculum. In some implementations, a subject may be based upon a weighting or preference indicated by a parent, guardian, teacher, or other administrator. For example, a parent may emphasize a subject that a student needs to work on based on historical performance or an expected level of challenge to the student. A subject may be weighted heavier if more questions should be asked in that area based on a student's needs and/or based on an upcoming assignment, test, quiz, project, etc. Subjects may also be picked at random based on a list of typical subjects that are appropriate for a grade and/or based on a list of current courses of a student (e.g., provided by a school, parent, or other administrator). A subject may also include a favorite subject of a student to encourage participation.

In operation 406, the method 400 may determine whether questions appropriate for the user are previously provided (e.g., by a school, a parent, a guardian, a teacher, a school administrator, etc.). If questions were previously provided the method may continue at operation 408. If questions were not previously provided the method may continue at operation 410.

At operation 408, the method 400 may use machine learning to identify an appropriate question out of provided questions based on a progression in learning of the user (e.g., a level of questions previously correctly answered, a level of test subject matter previously correctly answered, a level of questions previously incorrectly answered, a level of test subject matter previously incorrectly answered, etc.). In some implementations, machine learning may not be used. For example, questions may be arranged within a subject matter in different levels or tiers based on grade level, age level, test scores, subject grades, past authentication question responses, and/or other factors. In some implementations, questions may be loaded periodically into a system for an authentication application in advance of a test, project, quiz, or other assignment. For example, questions may be provided by a school in advance of a test and a student may periodically be prepared with practice questions during authentication attempts. After identifying an appropriate question out of a plurality of provided questions, the method 400 may continue at operation 412.

At operation 410, the method 400 may use machine learning to identify an appropriate question. For example, machine learning application 108 may be utilized to identify questions appropriate for a user based on education level, subject matter, results of prior questions, and/or other factors. Questions may be designed to progress in difficultly based on prior results, grades, or other factors. Machine learning application 108 may be used to determine an appropriate level of progression within a subject. In some implementations, identification of questions and progression of questions may be performed manually (e.g., arranging questions in tiers in advance). For example, questions may be arranged within a subject matter in different levels or tiers based on grade level, age level, test scores, subject grades, past authentication question responses, and/or other factors. In some implementations, questions may be loaded periodically into a system for an authentication application in advance of a test, project, quiz, or other assignment. For example, questions may be provided by a school in advance of a test and a student may periodically be prepared with practice questions during authentication attempts. After identifying an appropriate question and/or a progression of questions, the method 400 may continue at operation 412.

At operation 412, a question may be presented to a user for authentication. Questions may be displayed visually or presented in other manners (e.g., audio). For example, a question may be presented as a multiple choice question. In some implementations a series of questions may be provided. As discussed above in relation to method 300, receipt of a correct answer may allow a user to access desired functionality.

One or more methods described herein (e.g., method 300 and/or method 400) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., a Field-Programmable Gate Array (FPGA) and/or a Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
determining, using a computer processor, whether authentication is required for access to a portion of functionality of a device;
based on a determination that authentication is required, identifying a question to be answered to gain access to the portion of functionality of the device, a frequency of the authentication being determined by an administrator;
prompting the user of the device to provide a response to the question; and
in response to receiving a correct response to the question, granting access to the portion of functionality of the device.

2. The computer-implemented method of claim 1, wherein an answer to the question comprises an answer previously provided by someone other than the user of the device.

3. The computer-implemented method of claim 1, further comprising:
in response to receiving an incorrect answer to the question, providing the user with access to training material related to subject matter of the question; and
providing another opportunity to answer the question or a second question on the same subject matter.

4. The computer-implemented method of claim 1, wherein the question comprises a question directed towards educational subject matter.

5. The computer-implemented method of claim 4, wherein the identifying of the question to be answered to gain the access to the portion of functionality of the device comprises:
providing one or more inputs to a machine learning model; and
receiving a question directed to the user's educational level based on the one or more inputs.

6. The computer-implemented method of claim 1, wherein the question comprises a question of common knowledge designed to entertain the user.

7. The computer-implemented method of claim 1, wherein the determining of whether authentication is required for access to the portion of functionality of the device comprises at least one of:
detecting an execution of a specified program on the device;
determining that a specified period of time has elapsed since a prior authentication;
determining that a prior authentication has failed; or
determining that it is currently a specified time period requiring authentication.

8. The computer-implemented method of claim 1, further comprising:
installing on the device a client for controlling access to the portion of functionality of the device.

9. The computer-implemented method of claim 8, further comprising:
installing an administrative application for the client on a second device, separate from the device.

10. A system comprising:
one or more processors coupled to a computer-readable medium having stored thereon software instructions that, when executed by the one or more processors, cause the one or more processors to perform operations including:
determining whether authentication is required for access to a portion of functionality of a device;
based on a determination that authentication is required, identifying a question to be answered to gain access to the portion of functionality of the device, a frequency of the authentication being determined by an administrator;
prompting the user of the device to provide a response to the question; and
in response to receiving a correct response to the question, granting access to the portion of functionality of the device.

11. The system of claim 10, wherein an answer to the question comprises an answer previously provided by someone other than the user of the device.

12. The system of claim 10, further comprising:
in response to receiving an incorrect answer to the question, providing the user with access to training material related to subject matter of the question; and
providing another opportunity to answer the question or a second question on the same subject matter.

13. The system of claim 10, wherein the question comprises a question directed towards educational subject matter.

14. The system of claim 13, wherein the identifying of the question to be answered to gain the access to the portion of functionality of the device comprises:
providing one or more inputs to a machine learning model; and
receiving a question directed to the user's educational level based on the one or more inputs.

15. The system of claim 10, wherein the question comprises a question of common knowledge designed to entertain the user.

16. The system of claim 10, wherein the determining of whether authentication is required for access to the portion of functionality of the device comprises at least one of:
detecting an execution of a specified program on the device;
determining that a specified period of time has elapsed since a prior authentication;
determining that a prior authentication has failed; or
determining that it is currently a specified time period requiring authentication.

17. The system of claim 10, further comprising:
installing on the device a client for controlling access to the portion of functionality of the device.

18. The system of claim 10, further comprising:
installing an administrative application for the client on a second device, separate from the device.

19. A non-transitory computer-readable medium having stored thereon software instructions that, when executed by one or more processors, cause the one or more processors to perform operations including:
determining whether authentication is required for access to a portion of functionality of a device;
based on a determination that authentication is required, identifying a question to be answered to gain access to the portion of functionality of the device, a frequency of the authentication being determined by an administrator;
prompting the user of the device to provide a response to the question; and
in response to receiving a correct response to the question, granting access to the portion of functionality of the device.

20. The non-transitory computer-readable medium wherein the identifying of the question to be answered to gain the access to the portion of functionality of the device comprises:
providing one or more inputs to a machine learning model; and
receiving a question directed to the user's educational level based on the one or more inputs.
